(19) United States
(12) Patent Application Publication
(10) Pub. No.: US 2011/0153392 A1
(43) Pub. Date: Jun. 23, 2011

(54) SYSTEMS AND METHODS FOR SCHEDULING A PERIODIC COLLECTION OF ENVIRONMENTAL SAMPLES

(76) Inventor: Steven T. Pallad, Pleasanton, CA (US)

(21) Appl. No.: 12/644,532

(22) Filed: Dec. 22, 2009

(51) Int. Cl. G06Q 10/00; G06F 17/40; G06Q 50/00

(52) U.S. Cl. 705/7.41; 702/187

(57) ABSTRACT

According to some embodiments, a set of sampling sites may be automatically selected from a list of potential sampling sites. Each sampling site in the set may then be automatically associated with a list of analytes (e.g., in accordance with a pre-determined rule). A periodic collection of environmental samples from each of the sampling sites may then be automatically scheduled. An output may be provided for a user based on the scheduled periodic collection of environmental samples.

### BACKGROUND

In some cases, it may be necessary to collect environmental samples from a particular location or area (e.g., a factory or storage facility). Moreover, it may be necessary to collect samples from multiple sites at or near the location. For example, water samples may need to be collected from a number of different wells throughout a location to be tested for contamination. Such samples might need to be collected and tested to comply with, for example, a governmental regulation (e.g., associated with the Environmental Protection Agency) and/or a court order. Moreover, the regulation or order might specify a specific frequency to be associated with the sampling as well as list of chemicals or other materials for which the samples need to be tested. Further, in some cases a regulation or order might define an amount of redundant testing that needs to be performed to help ensure the accuracy and/or integrity of an environmental monitoring program. Scheduling such sample collections can be time consuming and error-prone task, especially when there are a relatively large number of sampling sites, analytes, and/or rules associated with an environmental monitoring program.

### SUMMARY

According to some embodiments, a set of sampling sites may be automatically selected from a list of potential sampling sites. Each sampling site in the set may then be automatically associated with a list of analytes (e.g., in accordance with a pre-determined rule). A periodic collection of environmental samples from each of the sampling sites may then be automatically scheduled. An output may be provided for a user based on the scheduled periodic collection of environmental samples.

Other embodiments may include: means for automatically selecting a set of sampling sites from a list of potential sampling sites; means for automatically associating each sampling site in the set with a list of analytes in accordance with a pre-determined rule; means for automatically scheduling a periodic collection of environmental samples from each of the sampling sites; and means for generating an output for the user based on the scheduled periodic collection of environmental samples.

A technical effect of some embodiments of the invention is an improved and automated ability to schedule periodic collections of environmental samples. With this and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a block level diagram of a system according to some embodiments.

FIG. 2 illustrates a method according to some embodiments of the present invention.

FIG. 3 is a block diagram of an environmental sample scheduling apparatus in accordance with some embodiments of the present invention.

FIG. 4 is a tabular view of a portion of a schedule database in accordance with some embodiments of the present invention.

FIG. 5 illustrates a system menu for a graphical user interface display according to some embodiments.

FIG. 6 illustrates a well sampling selection form display according to some embodiments.

FIG. 7 illustrates a portion of a well sampling form display according to some embodiments.

FIG. 8 illustrates another portion of a well sampling form display according to some embodiments.

FIG. 9 illustrates a well criteria selection display according to some embodiments.

FIG. 10 illustrates a sampling event management display according to some embodiments.

FIG. 11 illustrates a well list management display according to some embodiments.

FIG. 12 illustrates an analyte assignment display according to some embodiments.

FIG. 13 illustrates an analyte assignment display associated with a particular well according to some embodiments.

FIG. 14 illustrates a field duplicate selection display according to some embodiments.

FIG. 15 illustrates a field duplicate assignment display according to some embodiments.

FIG. 16 illustrates an analytical method selection display according to some embodiments.

FIG. 17 illustrates a well assignment display for a selected analytical method according to some embodiments.

FIG. 18 illustrates a sample selection display for a chain of custody according to some embodiments.

FIG. 19 illustrates a final chain of custody form display according to some embodiments.

FIGS. 20 through 23 illustrate a method according to one embodiment of the present invention.

### DETAILED DESCRIPTION

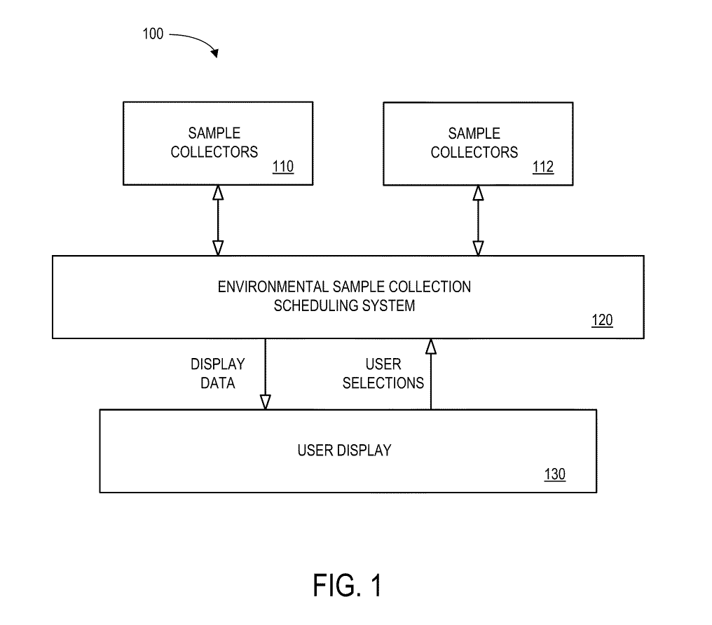

To address some of the problems described in the background section of this application, systems and methods for scheduling a periodic collection of environmental samples may be provided. For example, FIG. 1 is block diagram of a system 100 in accordance with some embodiments. In particular, an environmental sample collection scheduling system 120 (e.g., associated with an application or engine) may exchange information from a number of sample collectors 110, 112. The scheduling system 120 may also exchange data with one or more user displays 130. The scheduling system 120, sample collectors 110, 112, and user display 130 may then operate in accordance with any of the embodiments described herein.

According to some embodiments, the scheduling system 120, sample collectors 110, 112, and user display 130 facilitate an automated scheduling and/or collection of environmental samples. As used herein the term “automated” indicates that at least some part of a step associated with a process or service is performed with little or no human intervention. By way of examples only, the sample collectors 110, 112 and/or user display 130 might be associated with a Personal Computer (PC), a notebook computer, a server, an Internet data cloud, a workstation, and/or a Personal Digital Assistant (PDA). The scheduling system 120 might be associated with, for example, a server, an application, and/or a database.

Any of the devices described in connection with the system 100 might, according to some embodiments, exchange information via a communication network and/or use specific communication network protocols. For example, the sample collectors 110, 112 and/or user display 130 might be remote from the scheduling system 120 (e.g., information might be received from sample collectors 110, 112 via wireless handheld devices). As used herein, a device may be “remote” from the scheduling system 120 in that it is physically located distant from the scheduling system 120 and/or in that it communicates with the scheduling system 120 via one or more Internet and/or intranet communication networks and/or protocols.

As used herein, devices (including those associated with the scheduling system 120, sample collectors 110, 112, and user display 130) may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, an Ethernet network, a wireless LAN network, and/or an Internet Protocol (TCP/IP) network such as the Internet, an intranet, or an extranet. Note that any devices described herein may communicate via one or more such communication networks.

The devices of FIG. 1 might, according to some embodiments, be accessible via a Graphical User Interface (GUI). The GUI might be associated with a data exchange layer application and may be used, for example, to dynamically display and receive information in connection with environmental samples, schedules, and/or a configuration associated with the sample collectors 110, 112, the scheduling system 120, and/or the user display 130.

Although a single scheduling system 120 and user display 130 are shown in FIG. 1, any number of such devices and systems may be included. Moreover, various devices described herein might be combined or co-located according to embodiments of the present invention.

The scheduling system 120 may include a communication device (e.g., a port) to receive data from the plurality of sample collectors 110, 112 and/or the user display 130. The scheduling system 120 may further include a processor coupled to the communication device and a storage device in communication with the processor storing instructions adapted to be executed by the processor to perform a method in accordance with any of the embodiments described herein. For example, the scheduling system 120 may select a set of sampling sites from a list of potential sampling sites, and associate each sampling site in the set with a list of analytes. The scheduling system 120 might also, according to some embodiments, schedule a periodic collection of environmental samples from each of the sampling sites, and generate an output for a user based on the scheduled periodic collection of environmental samples.

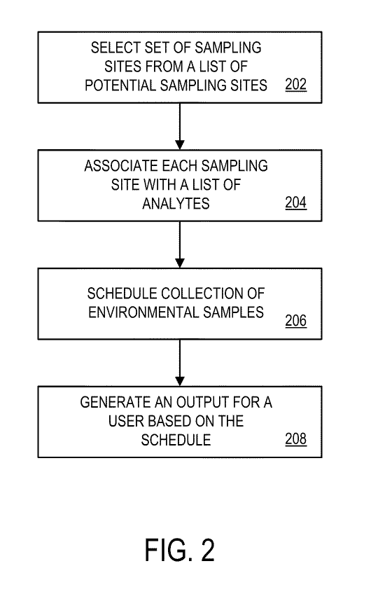

FIG. 2 illustrates one method that might be performed, for example, by the scheduling system 120 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 202, a set of sampling sites may be selected from a list of potential sampling sites. The potential sampling sites might be, for example, water wells located in or around an area of particular environmental interest (e.g., near a factory, a warehouse, or storage or processing facility). The sites included in the set might be selected, for example, based on governmental regulations and/or court orders. For example, certain sites might need to be sampled on a regular basis (e.g., a particular site might need to be sampled at least once per year). According to some embodiments, the set of sampling sites is automatically selected in accordance with one or more pre-determined rules.

At 204, each sampling site in the set may be associated with a list of analytes. As used herein, the term “analyte” might refer to any chemical, element, or characteristic of a sample that may be of environmental interest. By way of example only, an analyte might be associated with diesel or motor oils, gasoline, poly-chlorinated biphenyls, mercury, cyanide, sulfide, ammonia, copper, zinc, nickel, or pesticide chemicals. Note that other types of information may be considered an “analyte” in accordance with some embodiments of the present invention. For example, water temperature or a level of radiation might be considered an analyte in some embodiments. The analytes included in the list might be selected, for example, based on governmental regulations and/or court orders. For example, certain analytes might need to be sampled on a regular basis (e.g., a test for a particular analyte might need to be sampled at least once per year) and/or from a pre-determined number or percentage of sampling sites. According to some embodiments, the list of analytes is automatically selected in accordance with one or more pre-determined rules.

At 206, a periodic collection of environmental samples from each of the sampling sites may be scheduled. As used herein an environmental “sample” might be associated with a water sample (e.g., from a well), a soil sample, and/or an air sample. Note that in some embodiments, different types of samples might be scheduled together. Information about a scheduled sample collection might include, for example, a sample date, a sample time, a sample order (e.g., an order in which various sites should be visited), a sample taker or collector, and/or a sample identifier.

The schedule might be created, for example, based on governmental regulations and/or court orders. For example, certain sites and/or analytes might need to be sampled on a regular basis. The schedule might also be based on a map information (e.g., to determine an efficient path for sample collectors to take while gathering samples). According to some embodiments, the periodic collection is automatically scheduled in accordance with one or more pre-determined rules. Moreover, according to some embodiments the system may further automatically define at least one duplicate sampling site for the schedule. Note that in some embodiments a user may provide an adjustment to a set of sampling sites, lists of analytes, and/or a schedule. The system may then update and/or review the adjusted information as appropriate.

At 208, an output may be generated for a user based on the scheduled periodic collection of environmental samples. For example, the system might print a schedule to be used by sample collectors or transmit schedule information to sample collector devices (e.g., handheld wireless devices). According to some embodiments, the system may further automatically generate sample container labels and/or a chain of custody record.

In addition to the actions illustrated in FIG. 2, according to some embodiments the system may further facilitate a receiving of environmental samples along with associated sample data. For example, the system might review information about received samples (e.g., to determine whether a sufficient number of samples have been gathered by sample collectors). Moreover, according to some embodiments, the system may also facilitate analysis of a first environmental sample from a first sampling site based on the list of analytes associated with the first sampling site. For example, the system might arrange for the samples to be transported to laboratory for analysis and/or to receive result from the laboratory in connection with the samples. According to some embodiments, the system may also generate a report based on the results of the analysis. For example, the system might compile a document based on and including the results of the analysis along with an evaluation of compliance with one or more regulations and/or court orders.

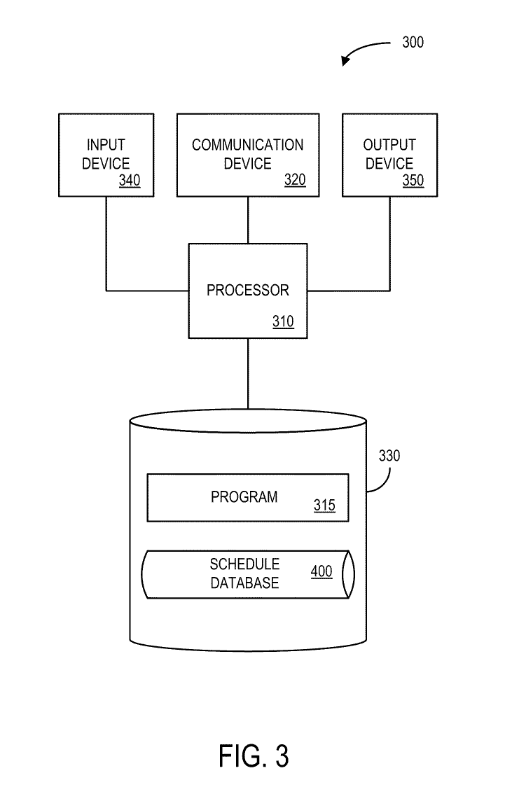

FIG. 3 is a block diagram of an environmental sample collection scheduling apparatus 300 in accordance with some embodiments of the present invention. The apparatus 300 might, for example, comprise a platform or engine similar to the scheduling system 120 illustrated in FIG. 1. The apparatus 300 comprises a processor 310, such as one or more INTEL® Pentium® processors, coupled to a communication device 320 configured to communicate via a communication network (not shown in FIG. 3). The communication device 320 may be used to exchange information with sample collectors and/or user displays.

The processor 310 is also in communication with an input device 340. The input device 340 may comprise, for example, a keyboard, a mouse, or computer media reader. Such an input device 340 may be used, for example, to enter configuration and/or management information in connection with environmental sample collection schedules. The processor 310 is also in communication with an output device 350. The output device 350 may comprise, for example, a display screen or printer. Such an output device 350 may be used, for example, to provide reports and/or display information associated with environmental samples and/or sampling schedules.

The processor 310 is also in communication with a storage device 330. The storage device 330 may comprise any appropriate information storage device, including combinations of magnetic storage devices (e.g., hard disk drives), optical storage devices, and/or semiconductor memory devices such as Random Access Memory (RAM) devices and Read Only Memory (ROM) devices. The storage device 330 stores a program 315 for controlling the processor 310. The processor 310 performs instructions of the program 35, and thereby operates in accordance any embodiments of the present invention described herein. For example, the processor 310 may select a set of sampling sites from a list of potential sampling sites and associate each sampling site in the set with a list of analytes. The processor 310 might also, according to some embodiments, schedule a periodic collection of environmental samples from each of the sampling sites and generate an output for the user based on the scheduled periodic collection of environmental samples.

As used herein, information may be “received” by or “transmitted” to, for example: (i) the environmental sample collection scheduling apparatus 300 from other devices; or (ii) a software application or module within the environmental sample collection scheduling apparatus 300 from another software application, module, or any other source.

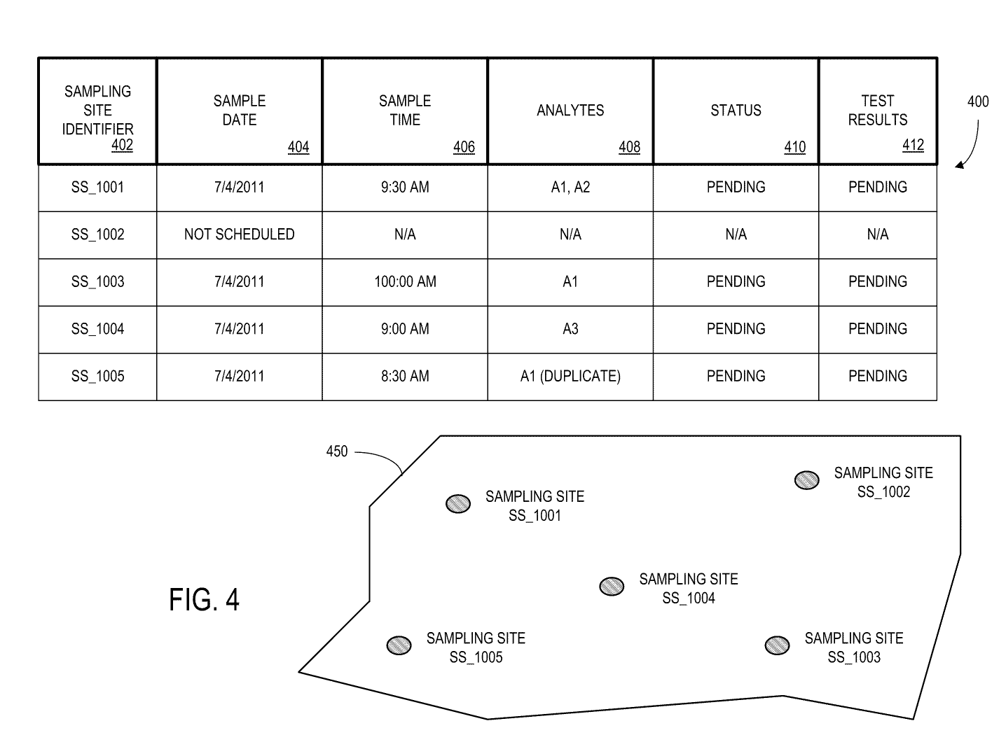

As shown in FIG. 3, the storage device 330 also stores the schedule database 400. One example of such a database 400 that may be used in connection with the environmental sample collection scheduling apparatus 300 will now be described in detail with respect to FIG. 4. The illustration and accompanying descriptions of the database presented herein are exemplary, and any number of other database arrangements could be employed besides those suggested by the figures. For example, different databases associated with different types of environmental sample collections might be stored at the apparatus 300.

FIG. 4 is a tabular view of a portion of the schedule database 400 in accordance with some embodiments of the present invention. The table includes entries associated with intelligent electronic devices. The table also defines fields 402, 404, 406, 408, 410, 412 for each of the entries. The fields specify: a sampling site identifier 402, a sample date 404, a sample time 406, a list of one or more analytes 408, a status 410, and test results 412. The information in the database 400 may be periodically created and updated based on information received from sample collectors and/or user displays.

The sampling site identifier 402 might, for example, be a unique alphanumeric code associated with a location (e.g., a well) at which an environmental sample may be collected. The sample date 404 might indicate when a sample should be (or was last) collected from that site. Note that not all sampling site identifiers 402 might have an associated sample date (e.g., SS_1002 is not scheduled to have a sample taken in the illustration of FIG. 4). The sample time 406 might indicate when the sample should be (or was last) collect on the sample date 404. Note that the sample date 404 and sample time 406 might comprise an ordered list of which sampling sites should be visited (e.g., in the example of FIG. 4, sampling sites would be visited in the following order: SS_1005, SS_1004 , SS_1001, SS_1003). The order might automatically be based, for example, at least in part on map information 450 associated with the sampling sites (e.g., including a latitude and longitude of each sampling site).

The list of one or more analytes 408 might indicate which analytes should be (or have already been) tested in connection that the sample. The status 410 might indicate whether or not a sample has been taken and/or received. The test result 412 might include, for example, the findings received from a laboratory in connection with a sample.

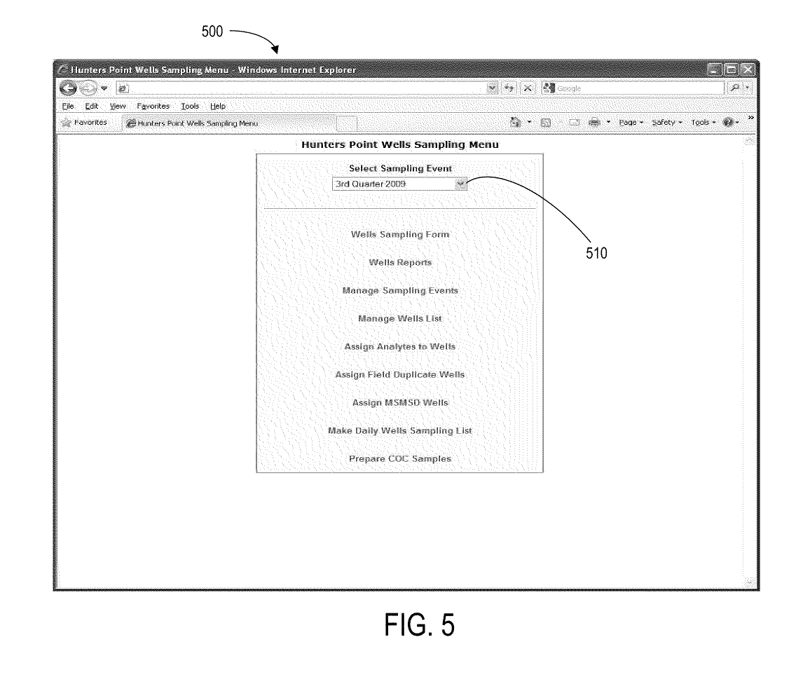

Note that information associated with an environmental sample collection scheduling system may be exchanged with a user via one or more GUI displays. For example, FIG. 5 illustrates a system menu 500 for a GUI display according to some embodiments. The menu 500 might be used, for example, to select a particular “event” via a sampling event pull-selection 510. As used herein, the term “event” might be associated with a particular collection schedule (e.g., a set of samples that are to be collected in the third quarter of the current year). After the appropriate event is sampled, the user might, according to some embodiments, access various well sampling forms and reports, manage sampling events and well lists, and/or assign analytes and duplicate wells.

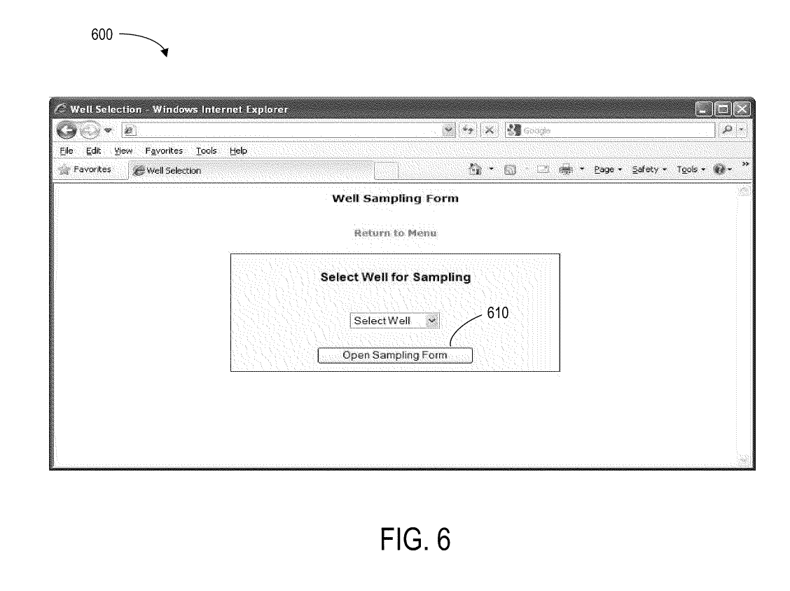

For example, if a user is interested in accessing a well sampling form, he or she might be presented with a well sampling selection form display 600 as illustrated in FIG. 6 according to some embodiments. The display might be used to select a particular well (e.g., via a drop down menu) and then activate an icon button 610 that opens a well sampling form for that particular well.

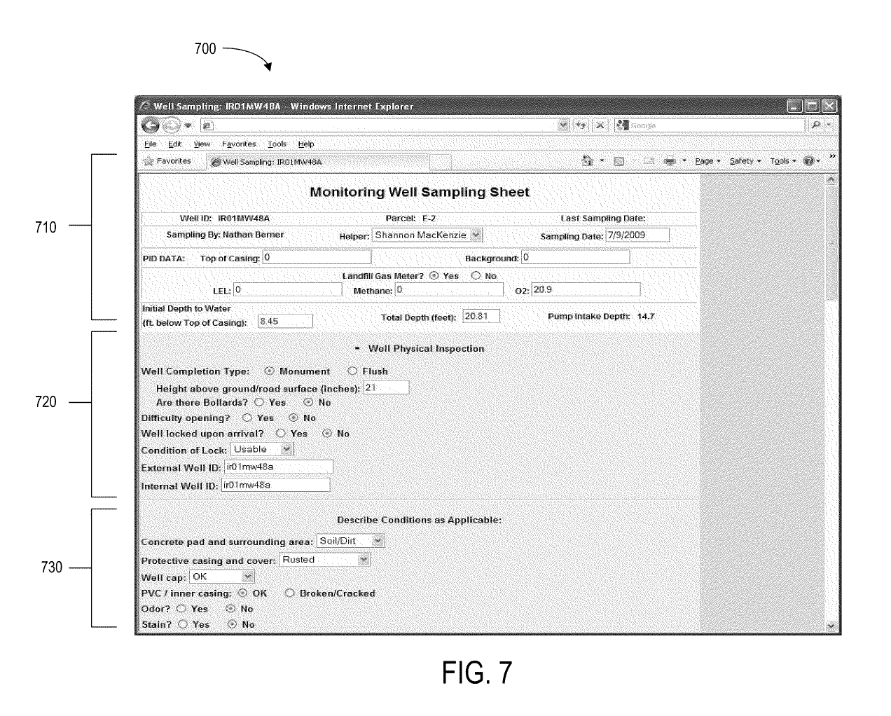

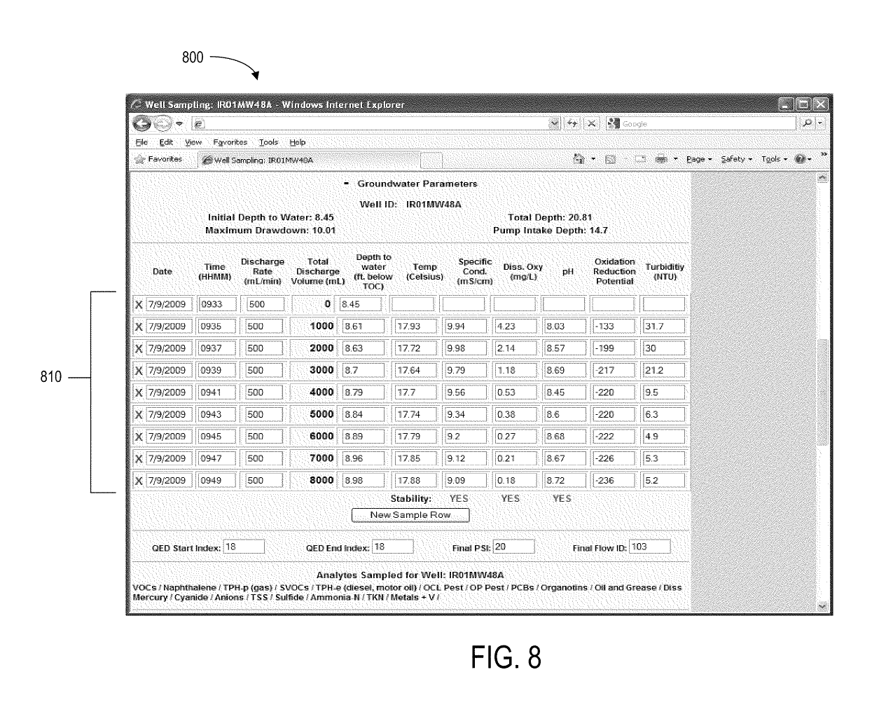

FIG. 7 illustrates a portion of a well sampling form display 700 according to some embodiments. The display 700 might be used, for example, to enter or view general information that identifies the well via an input portion 710. The display might also exchange other information about the well including information in portion 720 that results from a physical inspection of the well by a sample collector and/or data in portion 730 about the physical condition of the well and surrounding area. FIG. 8 illustrates another portion of a well sampling form display 800 according to some embodiments. In this case, a data area 810 may be provided to enter specific measured parameters for the well (e.g., discharge rates, depths, and/or temperatures). Note that a well sampling form might contain additional information, such as information about the equipment used to take the measurements.

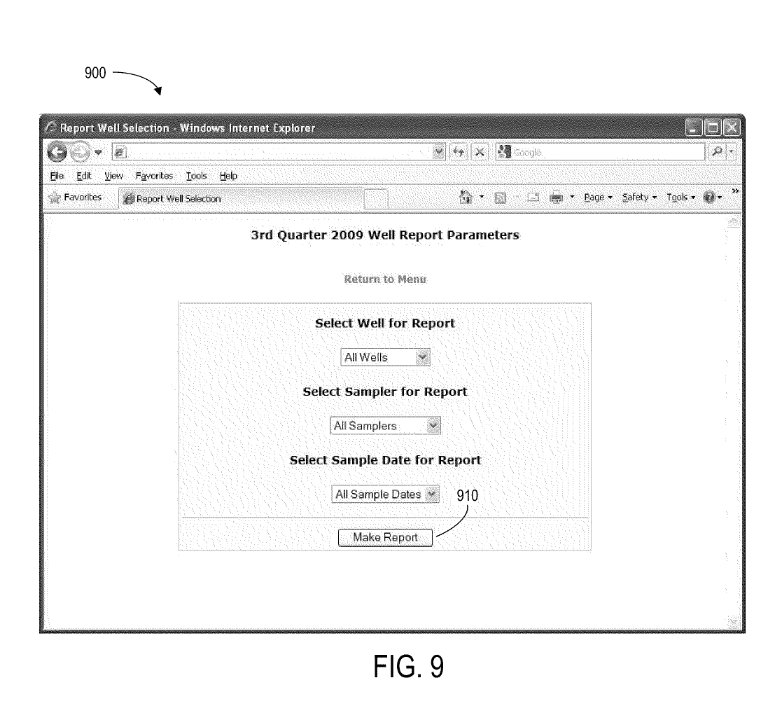

According to some embodiments, a user may generate a custom report in connection with environmental sample collections. For example, FIG. 9 illustrates a well criteria selection display 900 according to some embodiments. In this case, the user might select a well, a sampler or collector, and/or a date to be associated with a report. He or she may then select an icon 910 to generate the report for the selected well, sampler, and/or date (and the report might include, for example, sheets for each well that satisfy those criteria).

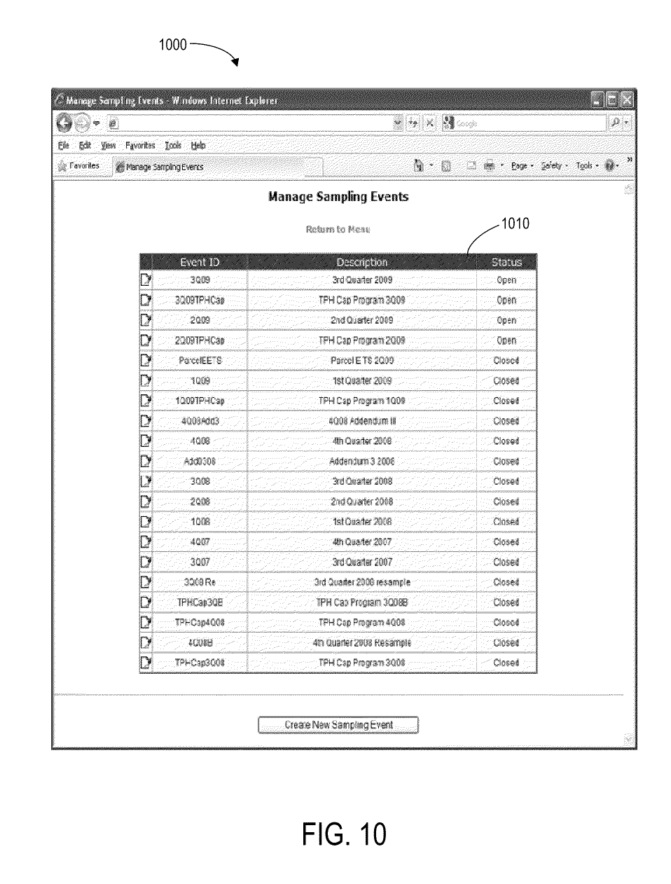

FIG. 10 illustrates a sampling event management display 1000 according to some embodiments. The display 1000 includes a table 1010 that list each defined event along with a description and status associated with that event. A user might then select one of those events if he or she wants to view and/or change information about that event and/or select an icon to create an entirely new event (e.g., by entering an identifier and/or name for the new event).

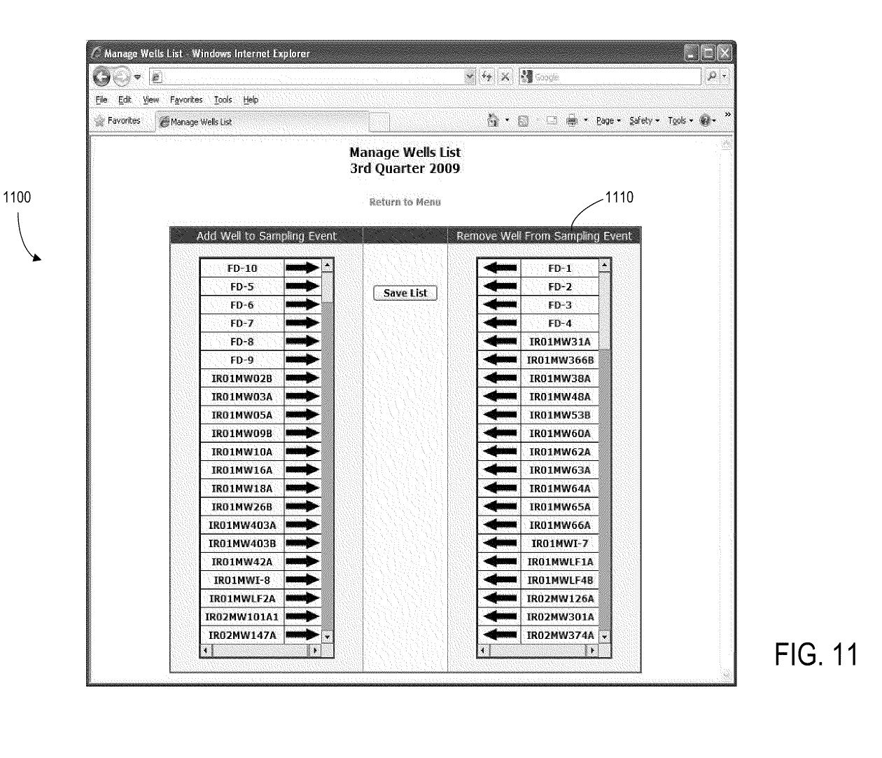

FIG. 11 illustrates a well list management display 1100 that might be displayed when the user selected an event via the table 1010 according to some embodiments. In particular, the display 1100 includes an interactive area 1110 where a user can add or remove wells from a sampling event (and an icon to save the list when he or she is done making adjustments to the event).

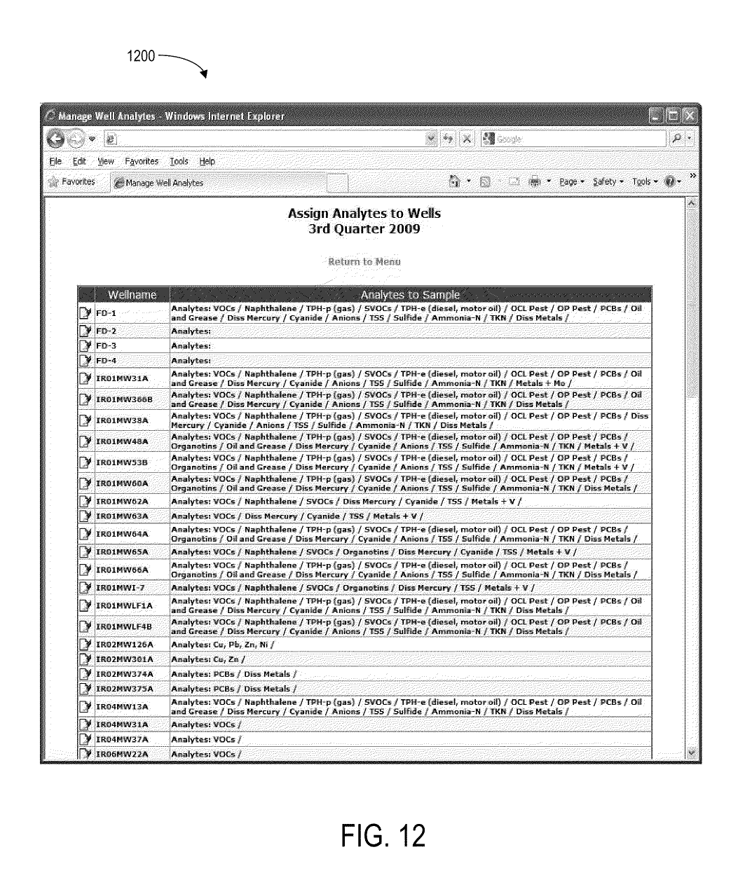

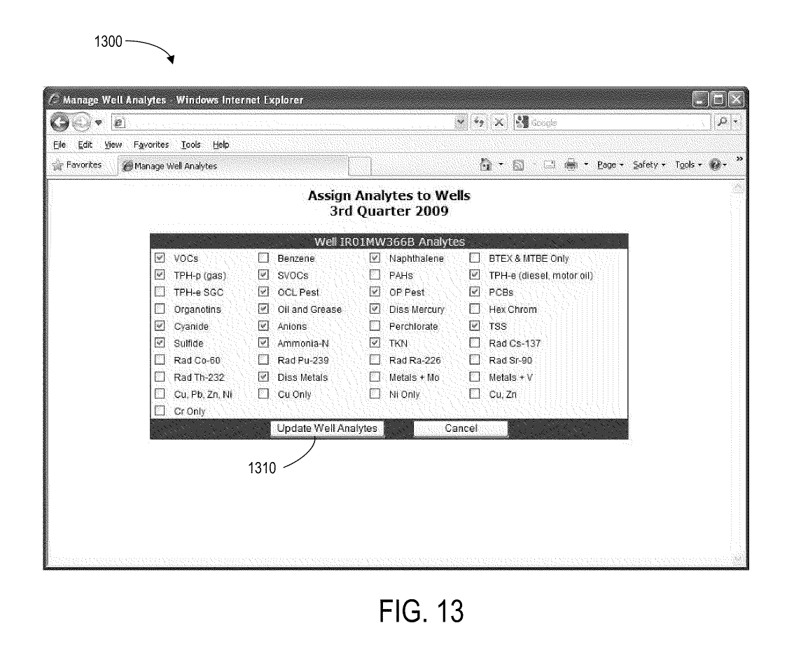

Each well included in a sampling event may be associated with a list of one or more analytes that will be tested. For example, FIG. 12 illustrates an analyte assignment display 1200 according to some embodiments. This display 1200 lists all wells included in the event along with the currently assigned analytes (e.g., analytes Cu, Pb, Zn, and Ni are currently assigned to well “IR02MW126A” illustrated in FIG. 12). Note that user might adjust which analytes are associated with which wells according to some embodiments. For example, FIG. 13 illustrates an analyte assignment display 1300 associated with a particular well according to some embodiments. In this example, a user can select (or deselect) individual analytes and then select an icon 1310 to save and update analytes for the selected well based on his or her adjustments

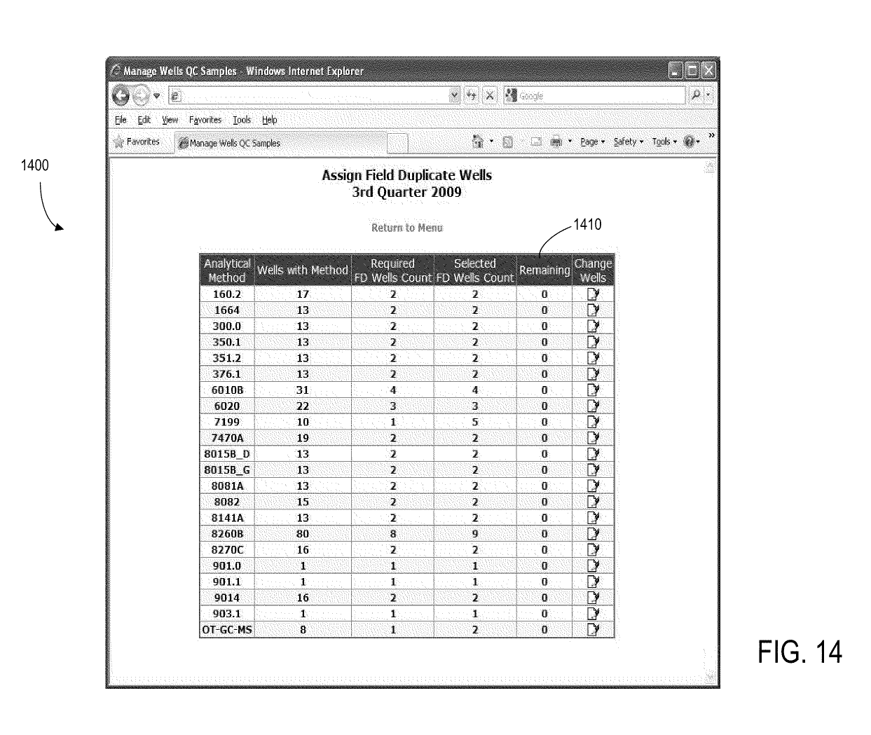

In some case, “duplicate” samples might be collected and duplicate tests might be performed to help improve and verify the accuracy of environmental monitoring. For example, duplicate sampling sites/analytical methods might be selected in connection with mercury testing. If the test results associated with an original and duplicate collection do not match, further investigation might be required. Note that in some cases, a regulation or court order might dictate how many duplicate samples/tests need to be designated (e.g., a pre-determined number or percentage of duplicates might need to be collected). FIG. 14 illustrates a field duplicate selection display 1400 according to some embodiments. The display 1400 includes a table 1410 listing analytical methods along with which well is being tested by that method, a required number of “Field Duplicates” (FD), and a number of “Remaining” field duplicates that need to be designated. In the example of FIG. 14, a sufficient number of field duplicates have been designated for all analytical methods (e.g., the selected count is greater than the required count for all analytical methods).

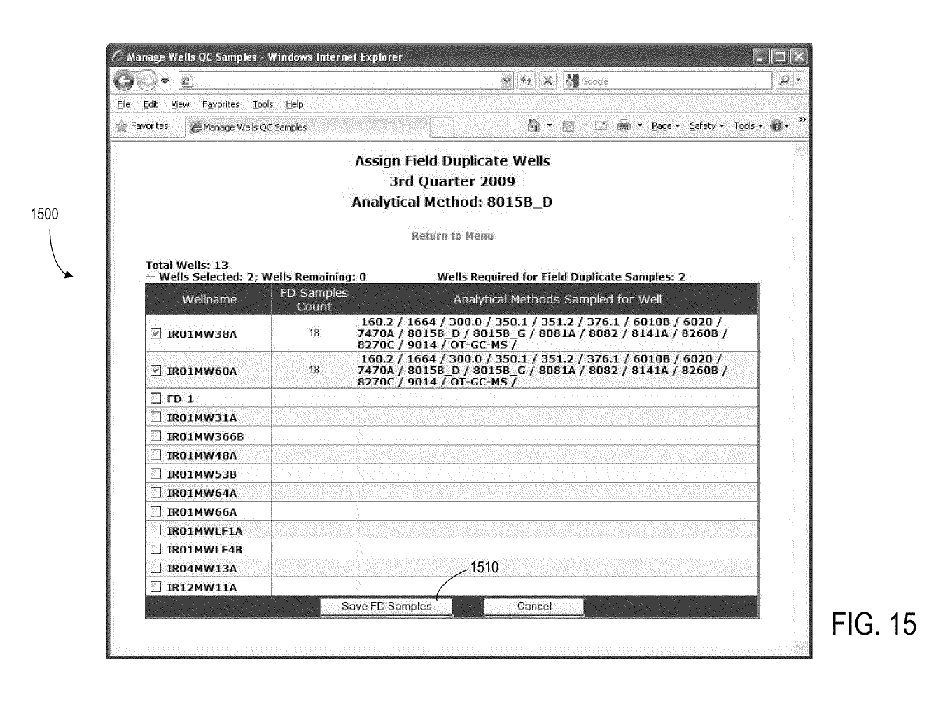

FIG. 15 illustrates a field duplicate assignment display 1500 according to some embodiments. This display 1500 lists each well along with a count of the number of duplicate samples associated with that well along with analytical methods that have been designated for that well (where an analytical “method” represents a list of analytes to be tested). A user may then select an icon 1510 to save the field duplicate sample information.

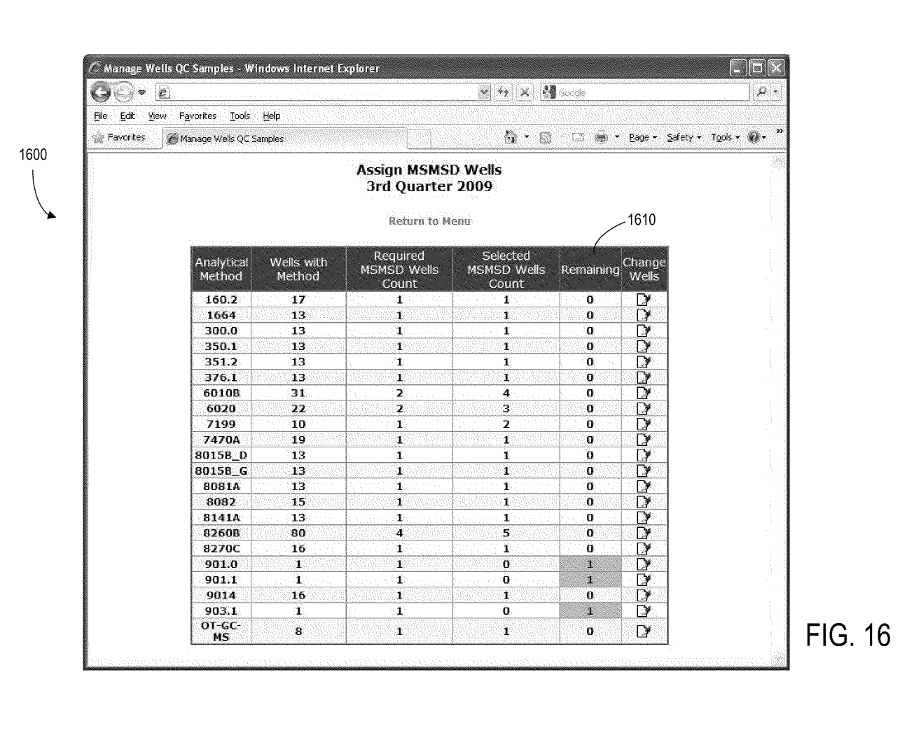

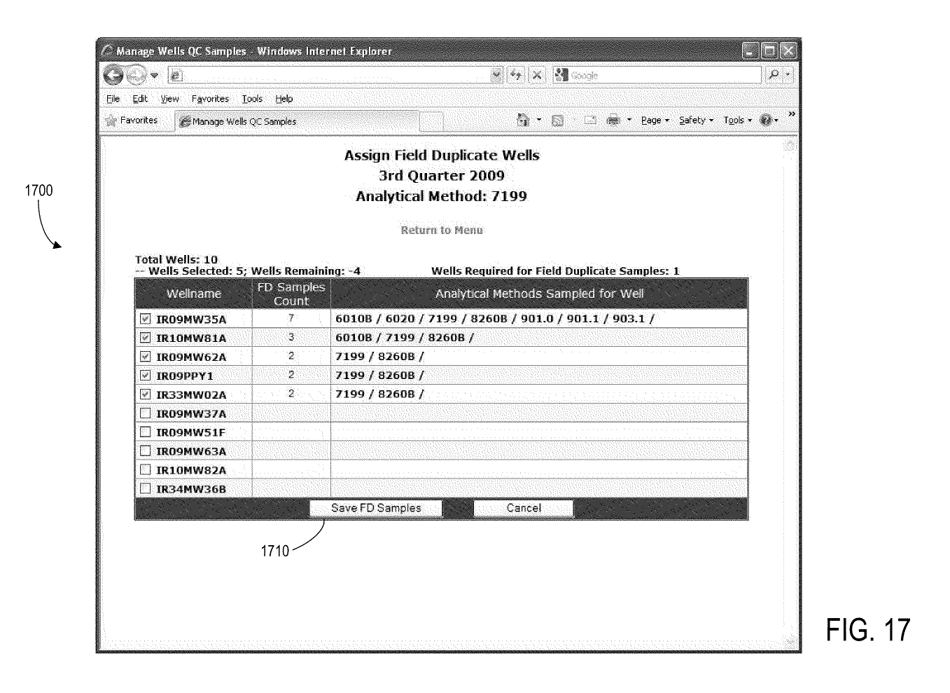

FIG. 16 illustrates an analytical method selection display 1600 according to some embodiments. In this display 1600, a table 1610 lists each analytical method along with a number of wells associated with that method, a required count, a currently selected count, and a number of wells that need to be added (if any) such that the currently selected count satisfies the required count. For example, analytical method “903.1” requires at least one well to be designated but currently has no wells associated with that method (and, as a result, a “remaining” count of one well is flagged as still needing to be assigned to that analytical method). FIG. 17 illustrates a well assignment display 1700 that may be used to review and/or adjust wells with selected analytical methods along with a save icon 1710 to save the field duplicate samples.

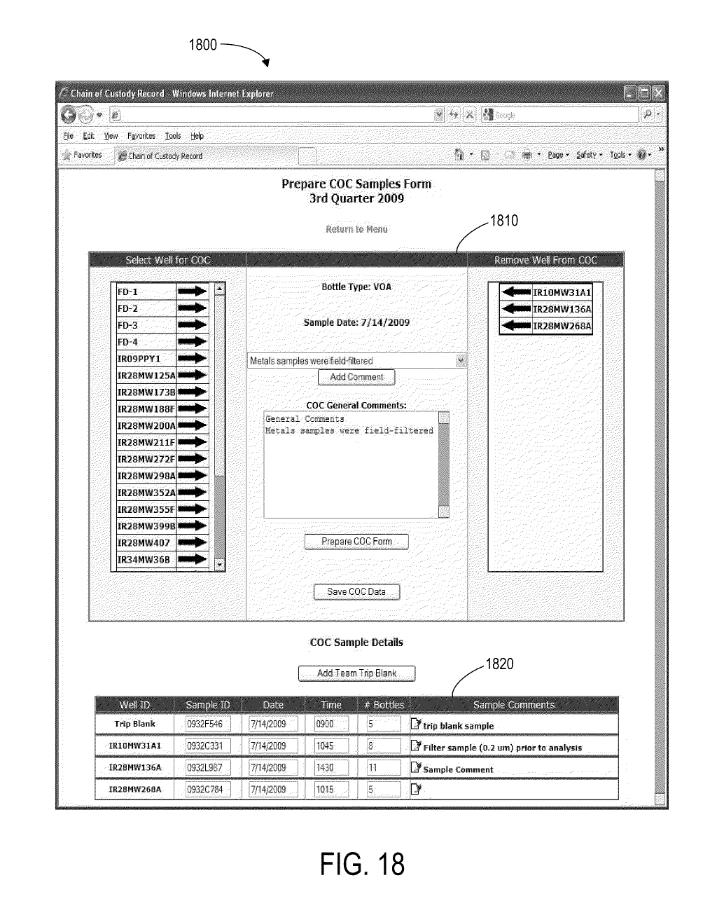

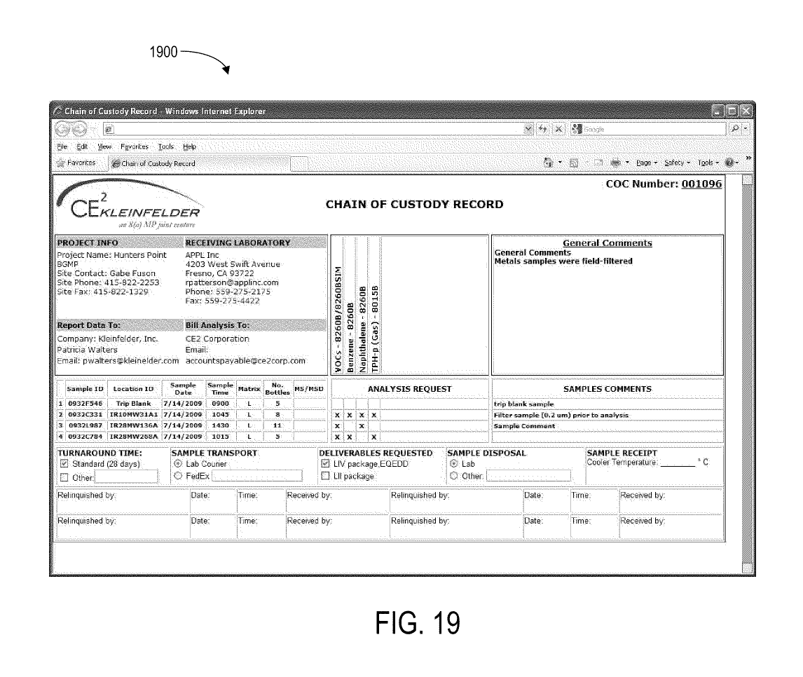

In some cases a “Chain Of Custody” (COC) sample form may help ensure the accuracy and integrity of an environmental monitoring program. FIG. 18 illustrates a sample selection display 1800 for a chain of custody according to some embodiments. The display 1800 includes an interactive area 1810 where a user can select or remove wells from a chain of custody samples form. The display also includes a table 1820 listing each well identifier, a sample identifier, a date, a time, a number of bottles, and any comments associated with the sample from that well. The display 1800 further includes an icon a user may select to “prepare COC form” for the selected wells. FIG. 19 illustrates a final chain of custody form display 1900 comprising a record that may be kept and/or audited for the monitoring program according to some embodiments.

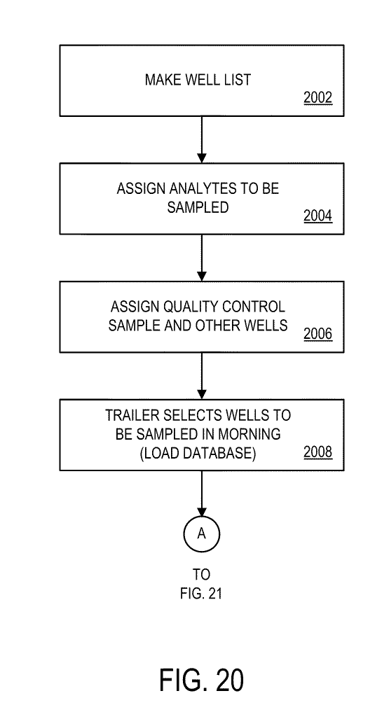

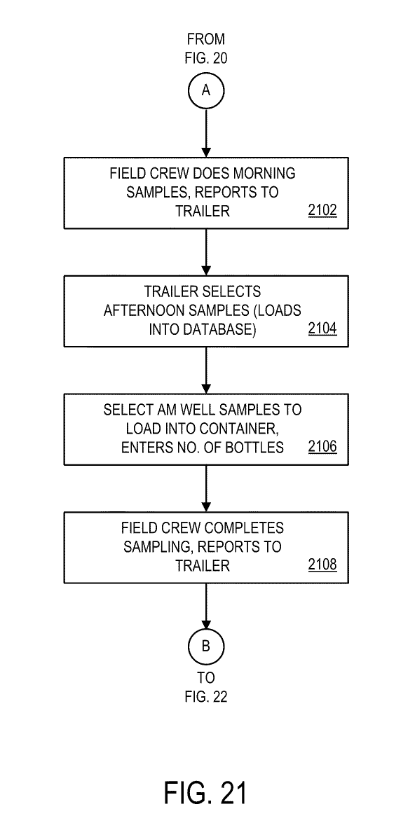

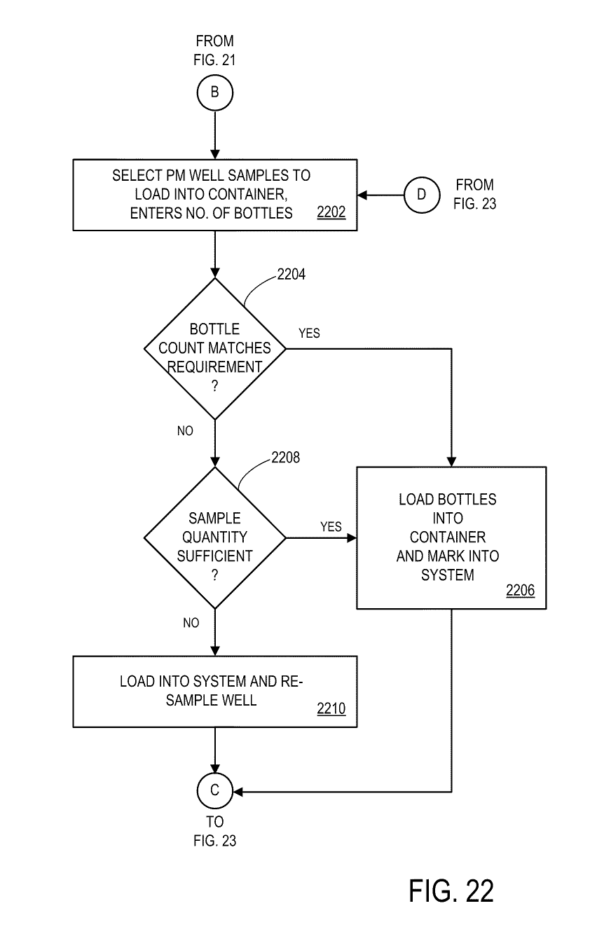

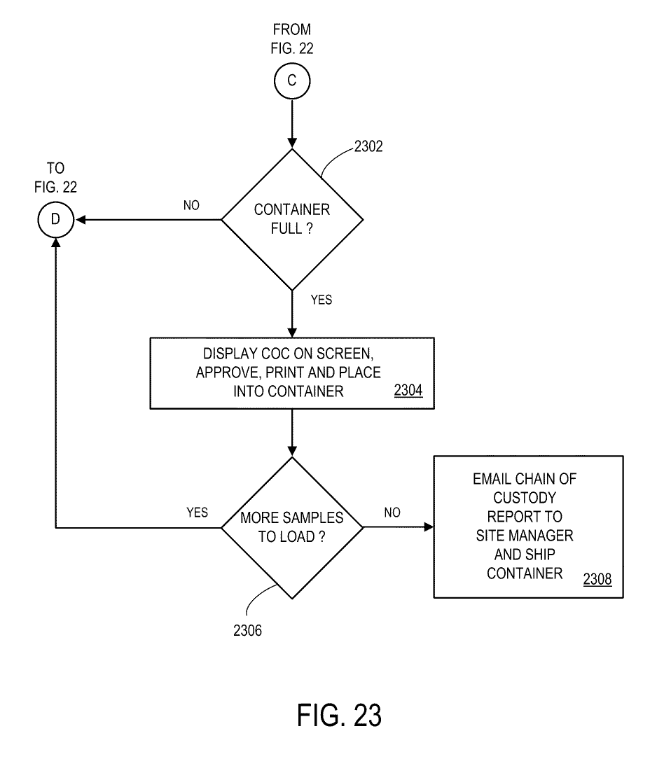

The various displays described herein may be used to schedule and collect environmental samples. For example, FIGS. 20 through 23 illustrates a method of performs these tasks according to one embodiment of the present invention. At 2002, a site manager might create a selected list of wells for a sample event (e.g., for a sampling event associated with an upcoming quarter). The list might be generated, for example, based on wells samples in a previous quarter, rules and regulations, a current season (e.g., whether it is a wet or dry season), and any special requests provided by a user or client.

At 2004, a site manager might confirm the analytes to be sampled for all wells using the sampling system. At 2006, a site administrator might assign quality control samples and other wells. The site administrator may then select wells to be sampled in a morning shift at 2008 and provide bottles to a field crew as needed (and this information might be stored into a database as appropriate).

At 2102, a field crew may sample the wells, report the completion to an on-site administrative office (e.g., a “trailer”) and return the bottles containing the samples to be tested. The site administrator may log those bottles and assign sample identifiers to the samples. The site administrator may then select wells to be sampled in an afternoon shift at 2104 and provide bottles to a field crew as needed (and this information might be stored into a database as appropriate).

At 2106, the site administrator may select samples collected during the morning shift and load them into a transportation container (for eventual transport to an environmental testing laboratory). Information about the number of bottles received may also be entered into the system (which can compare the number to a required threshold amount). At 2108, the afternoon shift may complete their sampling tasks and return the bottles containing the samples. The site administrator may log those bottles and assign sample identifiers to the samples.

At 2202, the site administrator may select samples collected during the afternoon shift and load them into a transportation container (for eventual transport to an environmental testing laboratory). Information about the number of bottles received may also be entered into the system (which can compare the number to a required threshold amount). If the bottle count matches a required number of bottles at 2204, the bottles may be loaded into the container and marked into the system at 2206.

If the bottle count does not match the required number of bottles at 2204, it is determined whether there is still enough volume of the sampled water to be tested at 2208. If so, the bottles may still be loaded into the container and marked into the system at 2206. If there is not enough water for testing at 2208, the samples on-hand may be loaded into the system and further sampling of wells will be required at 2210.

If the container is not full at 2302, the process may continue at 2202 (e.g., further samples are collected and placed into the container). When the container is full at 2302, a chain of custody form is displayed on a user display for approval, printed, and placed into the container at 2304. If more samples are to be collected at 2306, the process may continue at 2202 (e.g., further samples and collected and placed into a new container). When there are no more samples to be collected at 2306, a chain of custody report may be reviewed, approved, and transmitted to the site manager (e.g., via an email message) at 2308. In this way, samples may be collected and provided to a laboratory in an efficient and relatively error-free manner.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and apparatus described herein may be split, combined, and/or handled by external systems).

Applicants have discovered that embodiments described herein may be particularly useful in connection with certain types of environmental samples, although embodiments may be used in connection other types of information, such as soil and air samples.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An environmental sample scheduling apparatus, comprising:
a communication device to exchange information with at least one user;
a processor coupled to the communication device; and
a storage device in communication with said processor and storing instructions adapted to be executed by said processor to:
select a set of sampling sites from a list of potential sampling sites,
associate each sampling site in the set with a list of analytes,
schedule a periodic collection of environmental samples from each of the sampling sites, and
generate an output for the user based on the scheduled periodic collection of environmental samples.

2. The environmental sampling apparatus of claim 1, wherein a scheduled sample collection includes at least one of: (i) a sample date, (ii) a sample time, (iii) a sample order, (iv) a sample taker, or (v) a sample identifier.

3. The environmental sampling apparatus of claim 1, wherein the environmental samples are associated with at least one of: (i) water samples, (ii) soil samples, or (iii) air samples.

4. The environmental sampling apparatus of claim 1, wherein the processor is further to automatically generate at least one of: (i) sample container labels, or (ii) a chain of custody record.

5. The environmental sampling apparatus of claim 1, wherein the processor is further to facilitate a receiving of environmental samples along with associated sample data.

6. The environmental sampling apparatus of claim 5, wherein the processor is further to facilitate analysis of a first environmental sample from a first sampling site based on the list of analytes associated with the first sampling site.

7. The environmental sampling apparatus of claim 6, wherein the processor is further to generate a report based on the results of the analysis.

8. The environmental sampling apparatus of claim 1, wherein the processor is further to receive from a user an adjustment to at least one of: (i) the set of sampling sites, (ii) the lists of analytes, or (iii) the schedule.

9. The environmental sampling apparatus of claim 1, wherein the set of sampling sites is automatically selected in accordance with a pre-determined rule.

10. The environmental sampling apparatus of claim 1, wherein the list of analytes is automatically determined accordance with a pre-determined rule.

11. The environmental sampling apparatus of claim 1, wherein the periodic collection is automatically scheduled in accordance with a pre-determined rule.

12. The environmental sampling apparatus of claim 1, wherein the processor is further to automatically define at least one duplicate sampling site for the schedule.

13. A computer-implemented method, comprising:
automatically selecting a set of sampling sites from a list of potential sampling sites;
automatically associating each sampling site in the set with a list of analytes in accordance with a pre-determined rule;
automatically scheduling a periodic collection of environmental samples from each of the sampling sites; and
generating an output for the user based on the scheduled periodic collection of environmental samples.

14. The method of claim 13, wherein a scheduled sample collection includes at least one of: (i) a sample date, (ii) a sample time, (iii) a sample order, (iv) a sample taker, or (v) a sample identifier.

15. The method of claim 13, wherein the environmental samples are associated with at least one of: (i) water samples, (ii) soil samples, or (iii) air samples.

16. The method of claim 13, further comprising:
generating at least one of: (i) sample container labels, or (ii) a chain of custody record.

17. A computer-readable medium storing instructions adapted to be executed by a processor to perform a method, said method comprising:
automatically selecting a set of sampling sites from a list of potential sampling sites;
automatically associating each sampling site in the set with a list of analytes in accordance with a pre-determined rule;
automatically scheduling a periodic collection of environmental samples from each of the sampling sites; and
generating an output for the user based on the scheduled periodic collection of environmental samples.

18. The medium of claim 17, wherein a scheduled sample collection includes at least one of: (i) a sample date, (ii) a sample time, (iii) a sample order, (iv) a sample taker, or (v) a sample identifier.

19. The medium of claim 17, wherein the environmental samples are associated with at least one of: (i) water samples, (ii) soil samples, or (iii) air samples.

20. The medium of claim 17, wherein execution of the instructions further results in:
generating at least one of: (i) sample container labels, or (ii) a chain of custody record.
